(19) United States
(12) Patent Application Publication
(10) Pub. No.: US 2025/0347902 A1
(43) Pub. Date: Nov. 13, 2025

(54) OFF-PLANE W-MIRROR

(71) Applicant: Raytheon Company, Tewksbury, MA (US)

(72) Inventor: Tim P. Johnson, Torrance, CA (US)

(21) Appl. No.: 18/657,090

(22) Filed: May 7, 2024

(51) Int. Cl. G02B 17/02; G02B 17/06

(52) U.S. Cl. CPC G02B 17/023; G02B 17/06

(57) ABSTRACT

An apparatus continuously rotates an optical output about axis of rotation of the optical output. An input is centered on an optical axis of the apparatus and receives an optical input. An output is centered on the optical axis of the apparatus and provides an optical output. A group of five fixed fold mirrors is configured in a W orientation to receive the optical input and continuously rotates the optical output about the optical axis of the apparatus.

### TECHNICAL FIELD

This disclosure relates generally to optical projection systems. More specifically, this disclosure relates to mirror systems for rotating an image or beam to avoid supporting structures of an optical projection system.

### BACKGROUND

Existing optical systems provide for continuous beam rotation using large glass Dero-prisms having an associated motor and encoder. In the case of a laser system, the purpose of the Dero-prism is to reposition the laser beam to avoid hitting the window frame during azimuthal and elevational scanning of a separate head-mirror or telescope. The window frame often consists of an outer metal frame and a metal mullion between the window panes. The Dero is mounted between the laser and the scanning mirror or telescope. However, when Dero-prisms are used with moderate to high-powered lasers, the absorption and scatter caused by the glass of the Dero-prism is significant. The absorption reduces the power output of the laser and the scatter increases noise and possible damages to a receiving camera. In the case of an imaging system, the purpose of the Dero-prism is undo rotation caused by another scanning mirror. The Dero is mounted between the camera and the scanning mirror or telescope. However the Dero glass causes significant optical transmission loss. A K-mirror assembly is known to mitigate these effects in both laser and imaging systems, however it has issues as well. The K-mirrors must be oriented so the angle of incidence (AOI) is greater than 45 deg, which causes undesired polarization and absorption effects in the optical coating. Also the second mirror in the K-mirror assembly must be mounted far from the rotation axis causing significant moment of inertia (MOI). In the case of a linear polarized laser system, the laser beam's polarization axis often must be rotated. This is usually achieved using what is known as a half-wave plate. The half-wave plate is made of a birefringent crystal that is usually not suited for moderate to high-powered lasers. Thus, a system for more efficiently enabling multiple beam rotations that does not require the use of a Dero-prism, K-mirror, or half-wave plate would be beneficial.

It is known that a mirror assembly or prism with an odd number of reflections flips the beam/image in the plane of the optical axis. Prior art Dero optics constrain the optical axis to a plane.

### SUMMARY

This disclosure relates to mirror systems for continuously rotating an image or beam to avoid supporting structures of an optical projection system.

In a first embodiment, an apparatus continuously rotates an optical output about an axis of rotation of the optical output. An input is centered on an optical axis of the apparatus and receives the optical input. An output is centered on the optical axis of the apparatus and provides an optical output. A group of five fixed fold mirrors is configured in a W orientation to receive the optical input and continuously rotates the optical output about the optical axis of the apparatus.

In a second embodiment, an apparatus continuously rotates an optical output about an axis of rotation of the optical output. An input is centered on an optical axis of the apparatus and receives the optical input. An output is centered on the optical axis of the apparatus and provides an optical output. A group of five fixed fold mirrors is configured in a W orientation to receive the optical input and continuously rotates the optical output about the optical axis of the apparatus. The W orientation of the group of five fixed fold mirrors provides an angle of incidence between the five fixed fold mirrors of no greater than 45°. A support structure maintains the group of five fixed fold mirrors in a fixed orientation with respect to each other.

In a third embodiment, an apparatus continuously rotates an optical output about an axis of rotation of the optical output. An input beam is centered on the rotation axis of the apparatus and receives the optical input. An output is centered on the rotation axis of the apparatus and provides an optical output. A group of five fixed fold mirrors configured in a W orientation receives the optical input and continuously rotates the optical output about the rotation axis of the apparatus. The group of five fixed fold mirrors further comprise a first mirror associated with the input of the apparatus and centered on the rotation axis of the apparatus. A second mirror is associated with the output of the apparatus and centered on the optical axis of the apparatus. A third mirror located at a first transition point of the W orientation receives a reflected optical input from the second optical mirror. A fourth optical mirror located at a second transition point of the

W orientation receives a reflected optical input from the third optical mirror. A fifth optical mirror located at a third transition point of the W orientation receives a reflected optical input from the fourth optical mirror and reflects the optical input to the second mirror. The W orientation of the group of five fixed fold mirrors provides an angle of incidence between the five fixed fold mirrors of no greater than 45°.

Other technical features may be readily apparent to one skilled in the art from the following figures, descriptions, and claims.

### BRIEF DESCRIPTION OF THE DRAWINGS

FIG. 1 illustrates a window screen assembly requiring the use of continuous beam rotation to avoid obstructions;

FIG. 2 illustrates and on-axis, obscured telescope with Coude path that requires continuous beam rotation to avoid obstructions;

FIG. 3A illustrates a side view of an off-plane W-mirror assembly according to this disclosure;

FIG. 3B illustrates a perspective view of the off-plane W-mirror assembly;

FIG. 4 illustrates a swept volume area required by the off-plane W-mirror assembly; and

FIG. 5 illustrates the rotation of the inputs and outputs of the off-plane W-mirror assembly about the rotational axis of the assembly.

### DETAILED DESCRIPTION

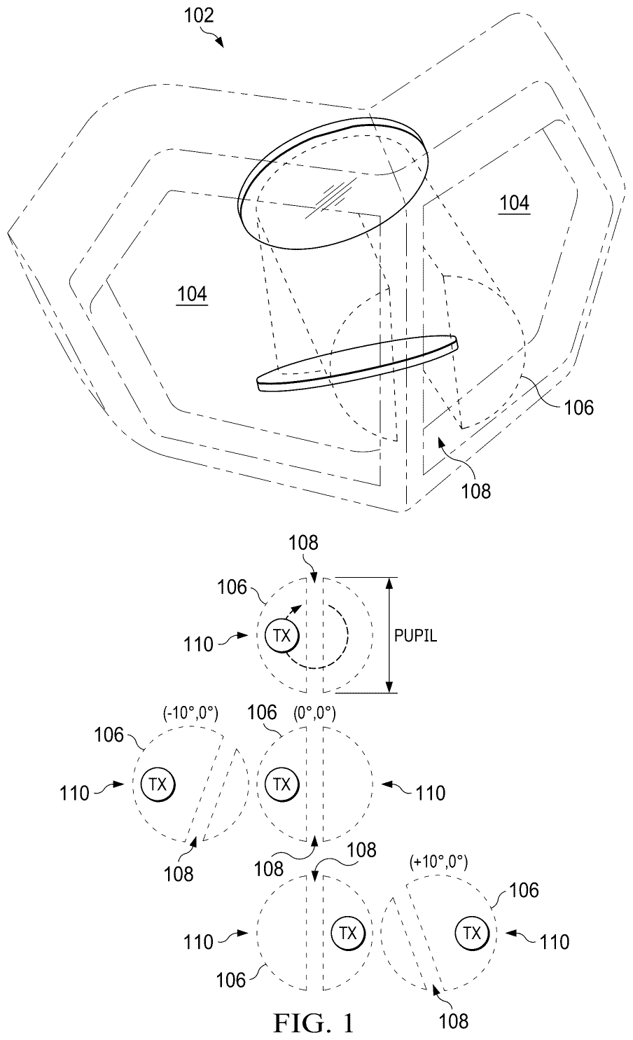

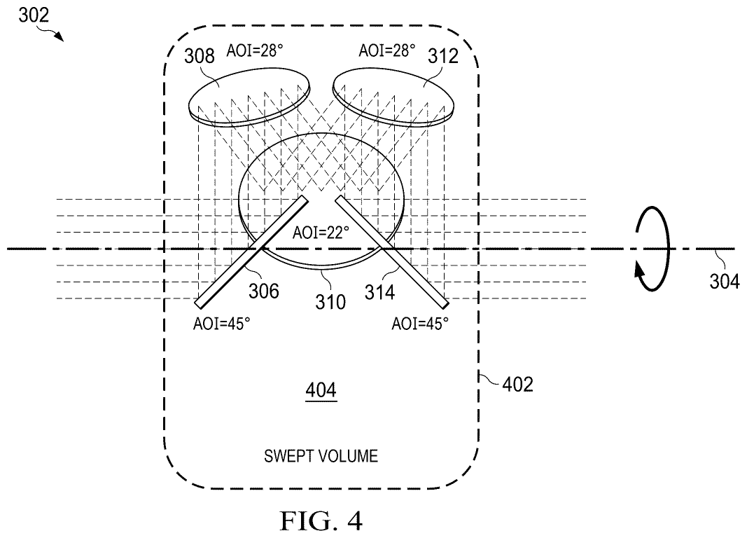

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

Referring now to FIG. 1, there is illustrated a window screen assembly that requires the use of beam rotation. In this case, a pair of window screens 104 have a laser beam 106 projected therethrough. The projected laser beam 106 must avoid a window screen assembly mullion 108 separating the pair of window screens 104. The aperture 110 of the camera or other detecting structure will always have the window screen assembly mullion 108 within its pupil. However, the transmitted laser beam 106 must be rotated to different positions to avoid striking the window screen assembly mullion 108. This movement is achieved by the beam rotation.

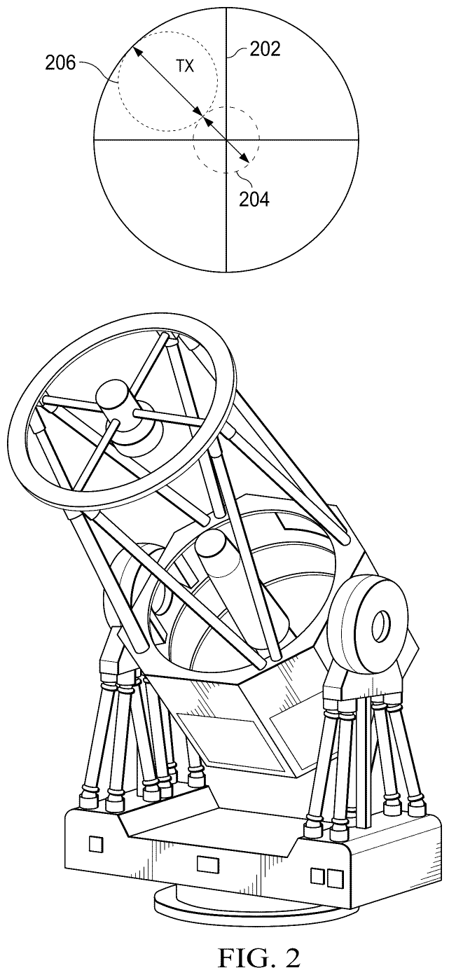

Referring now to FIG. 2, there is illustrated an on-axis, obscured telescope with Coude path. Like the window screen assembly 102 discussed with respect to FIG. 1, the telescope includes several obstructions comprised of the struts 202 and an obscuration 204. The transmitted beam 206 must be rotated to different areas to avoid being partially blocked by the struts 202 and obscuration 204.

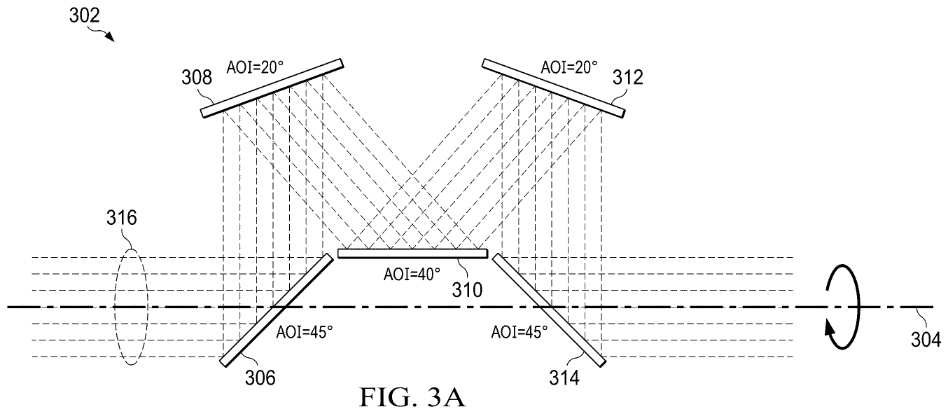

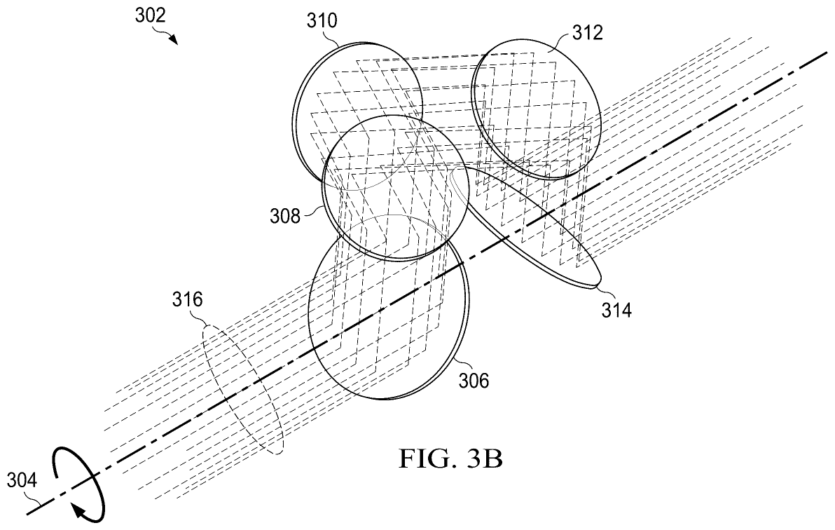

FIGS. 3A and 3B illustrate a side view and perspective view of an off-plane W-mirror assembly 302 which may be used for rotating a received laser beam or image about the rotation axis 304 of the off-plane W-mirror assembly. The off-plane W-mirror assembly 302 consists of a group of five fixed mirrors 306-314, which may in one embodiment comprise fold mirrors. Incoming laser beams 316 are input to the W-mirror assembly 302 at an input and intersect with a first mirror 306. The first mirror 306 reflects the beam toward a second mirror 308 at a 45° angle of incidence (AOI). The laser beam 316 reflects off the second mirror 308 toward a third mirror 310 at an angle of incidence of 20°. The laser beam 316 next reflects off the mirror 310 toward a fourth mirror 312 at an angle of incidence of 40°. The laser beam 316 then reflects off mirror 312 and an angle of incidence of 20° toward mirror 314. Finally, the laser beam reflects off mirror 314 in a direction parallel to the rotation axis 304 at an angle of incidence of 45°.

The orientation of the mirrors 306-314 enable the angle of incidence at each of the mirrors to remain at 45° or below. This provides a number of advantages over other solutions such as a K-mirror which includes an angle of incidence of greater than 45°. Maintaining the angle of incidence at no greater than 45° provides a number of advantages. AOIs of 45° or less enable for a reduction in the size of the mirrors 306-314 that are used. Larger angles of incidence require the use of larger mirrors. Additionally, higher angles of incidence can have undesired absorption and polarization effects due to the coatings on the mirrors. For example, gold and silver coated mirrors can have strange affects at larger angles of incidence greater than 50°. Thus, maintaining the angle of incidence at 45° or less within the W-mirror assembly 302 provides a number of beneficial effects.

The reference to the assembly as a W mirror comes from the fact that the pathway of the laser beams intersecting the mirrors 306-314 mimics those of a letter W (or a letter M if upside down as shown in FIGS. 3A and 3B). The mirrors 306 and 314 are located at the top beginning and ending points of the W, the mirrors 308 and 312 are located at the side transition points of the W, and the mirror 310 is located at the midpoint transition of the W. The use of the W-mirror assembly 302 configuration of mirrors 306-314 provides for a more compact configuration of the mirrors when rotating about the rotational axis 304. The more compact orientation of the mirrors 306-314 reduces the moment of inertia of the apparatus caused when the W-mirror assembly is being rotated about the rotational axis 304. The reduced moment of inertia enables the use of less powerful motors in order to enable rotation of the W-mirror assembly about the rotation axis 304.

The mirrors 306-314 of the off-plane W-mirror assembly 302 are contained within a support structure 402 that enables the mirrors 306-314 to rotate about the rotational axis 304 of the W-mirror assembly 302. The rotation axis 304 runs through the center of the mirrors 306 and 314. The mirrors 308, 310 and 312 are located a predetermined distance from the rotational axis 304 to enable the associated angle of incidence of 20° associated with mirrors 308 and 312 and 40° associated with mirror 310. Thus, when the entire W-mirror assembly 302 rotates the mirrors 308, 310 and 312 will rotate in a circular path about the rotation axis 304 within a swept volume area 404 within the support structure 402 of the W-mirror assembly 302. Nothing but the mirrors 306-314 should be located within the swept volume area 404 of the W-mirror assembly 302 in order to prevent the mirrors 306-314 from colliding with other items within the swept volume area 404. By positioning the third mirror off-plane from the other four mirrors, this reduces the total height of the assembly from the optical axis, thus reducing the moment of inertia (MOI) of the rotating assembly. Positioning the third mirror off-plane is not simply a redistribution of mass or conservation of total volume of the parts because the third mirror is positioned in the swept volume. No other parts that are not part of the rotating W-mirror assembly may be positioned in the swept volume or they will collide.

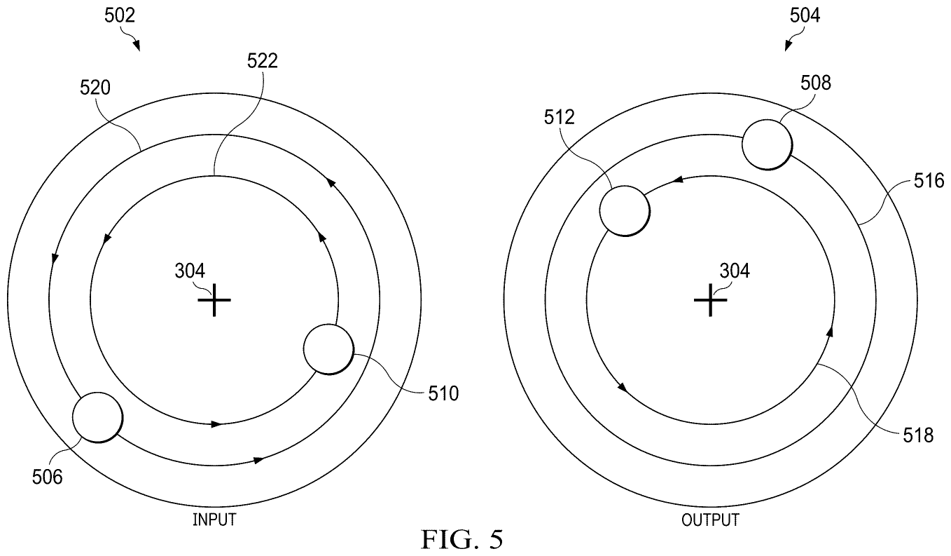

The rotation of the off-plane W-mirror assembly 302 enables a laser beam intersecting the mirrors 306-314 to be continuously rotated about the rotation axis 304 as more particularly illustrated in FIG. 5. FIG. 5 illustrates the input 502 and the output 504 of the off-plane W-mirror assembly 302. The input 502 illustrates two separate laser beams provided at the input and being projected to the output through the series of mirrors 306-314 discussed with respect to FIG. 3. Input location 506 provided by a laser is provided to the input 502 and output at 508 at the output 504 at a position that is rotated 180° from the input location 506. Similarly, input location 510 is rotated to an output location 512 at the output 504 that is 180° rotated from its input location 510. The 180° rotation of the location is caused by the reflections through the series of mirrors 306-314. While the output locations 512 and 508 are shown at fixed positions within the output 504, the output locations 508 and 512 may be rotated about a circular path centered on the rotation axis 304. The rotation path 516 is associated with output location 508, and the rotation path 518 is associated with output location 512. The input locations 506 and 510 may similarly rotate about a rotation path 520 and 522 associated with the input 502. The output locations 512 and 508 may be rotated continuously about the rotation axis 304 in order to avoid obstructions within the output pathway such as those described with respect to FIGS. 1 and 2.

While the above discussion has been made with respect to a laser beam intersecting the mirrors 306-314 and being projected toward an output, an image may be used rather than a laser beam. In this case, the overall orientation of the image is rotated about the rotation axis 304 between 0° and 360°. In a further embodiment, the off-plane W-mirror assembly 302 may be substituted for a half wave polarization plate. In this case, rather than rotating the position of an output laser beam about the rotational axis 304, a linear polarized laser beam that is centered upon the rotational axis 304 is provided at the input 502. The mirrors may then be rotated about the rotational axis 304 in order to rotate the polarization of the linearly polarized laser.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus for continuously rotating an optical output about axis of rotation of the optical output, comprising:
an input centered on an optical axis of the apparatus for receiving an optical input;
an output centered on the optical axis of the apparatus for providing the optical output; and
a group of five fixed fold mirrors configured in a W orientation to receive the optical input and continuously rotate the optical output about the optical axis of the apparatus.

2. The apparatus of claim 1 further comprising a support structure for maintaining the group of five fixed fold mirrors in a fixed orientation with respect to each other.

3. The apparatus of claim 1, wherein the W orientation of the group of five fixed fold mirrors provides an angle of incidence of beams reflected between the five fixed fold mirrors of no greater than 45°.

4. The apparatus of claim 1 further comprising a support structure for providing a swept volume area in which on the group of five fixed fold mirrors may rotate in order to rotate the optical output about the optical axis of the apparatus.

5. The apparatus of claim 1, wherein the group of five fixed fold mirrors further comprises:
a first mirror associated with the input of the apparatus and centered on the optical axis of the apparatus;
a second mirror associated with the output of the apparatus and centered on the optical axis of the apparatus;
a third mirror located at a first transition point of the W orientation for receiving a reflected optical input from the first mirror;
a fourth optical mirror located at a second transition point of the W orientation for receiving a reflected optical input from the third mirror; and
a fifth optical mirror located at a third transition point of the W orientation for receiving a reflected optical input from the fourth optical mirror and reflecting the optical input to the second mirror.

6. The apparatus of claim 1, wherein the optical input and the optical output comprises a laser beam.

7. The apparatus of claim 1, wherein the optical input and the optical output comprises an image.

8. The apparatus of claim 1, wherein the optical input and the optical output comprises a linearly polarize laser beam.

9. An apparatus for continuously rotating an optical output about axis of rotation of the optical output, comprising:
an input centered on an optical axis of the apparatus for receiving an optical input;
an output centered on the optical axis of the apparatus for providing the optical output;
a group of five fixed fold mirrors configured in a W orientation to receive the optical input and continuously rotate the optical output about the optical axis of the apparatus, wherein the W orientation of the group of five fixed fold mirrors provides an angle of incidence of beams reflected between the five fixed fold mirrors of no greater than 45°; and
a support structure for maintaining the group of five fixed fold mirrors in a fixed orientation with respect to each other.

10. The apparatus of claim 9, wherein the support structure provides a swept volume area in which on the group of five fixed fold mirrors may rotate in order to rotate the optical output about the optical axis of the apparatus.

11. The apparatus of claim 9, wherein the group of five fixed fold mirrors further comprises:
a first mirror associated with the input of the apparatus and centered on the optical axis of the apparatus;
a second mirror associated with the output of the apparatus and centered on the optical axis of the apparatus;
a third mirror located at a first transition point of the W orientation for receiving a reflected optical input from the first mirror;
a fourth optical mirror located at a second transition point of the W orientation for receiving a reflected optical input from the third mirror; and
a fifth optical mirror located at a third transition point of the W orientation for receiving a reflected optical input from the fourth optical mirror and reflecting the optical input to the second mirror.

12. The apparatus of claim 9, wherein the optical input and the optical output comprises a laser beam.

13. The apparatus of claim 9, wherein the optical input and the optical output comprises an image.

14. The apparatus of claim 9, wherein the optical input and the optical output comprises a linearly polarize laser beam.

15. An apparatus for continuously rotating an optical output about axis of rotation of the optical output, comprising:
an input centered on an optical axis of the apparatus for receiving an optical input;
an output centered on the optical axis of the apparatus for providing the optical output; and
a group of five fixed fold mirrors configured in a W orientation to receive the optical input and continuously rotate the optical output about the rotation axis of the apparatus, wherein the group of five fixed fold mirrors further comprises:
a first mirror associated with the input of the apparatus and centered on the rotation axis of the apparatus;
a second mirror associated with the output of the apparatus and centered on the rotation axis of the apparatus;
a third mirror located at a first transition point of the W orientation for receiving a reflected optical input from the first mirror;
a fourth optical mirror located at a second transition point of the W orientation for receiving a reflected optical input from the third mirror;
a fifth optical mirror located at a third transition point of the W orientation for receiving a reflected optical input from the fourth optical mirror and reflecting the optical input to the second mirror; and
wherein the W orientation of the group of five fixed fold mirrors provides an angle of incidence of beams reflected between the five fixed fold mirrors of no greater than 45°.

16. The apparatus of claim 15 further comprising a support structure for maintaining the group of five fixed fold mirrors in a fixed orientation with respect to each other.

17. The apparatus of claim 15 further comprising a support structure for providing a swept volume area in which on the group of five fixed fold mirrors may rotate in order to rotate the optical output about the optical axis of the apparatus.

18. The apparatus of claim 15, wherein the optical input and the optical output comprises a laser beam.

19. The apparatus of claim 15, wherein the optical input and the optical output comprises an image.

20. The apparatus of claim 15, wherein the optical input and the optical output comprises a linearly polarize laser beam.
